(19) United States
(12) Patent Application Publication
(10) Pub. No.: US 2008/0306874 A1
(43) Pub. Date: Dec. 11, 2008

(54) SYSTEM AND METHOD FOR MANAGING A PRODUCT THROUGH A DISTRIBUTION CHAIN

(76) Inventor: Charles A. White, Oakland, CA (US)

Correspondence Address: WILLIAM J. KOLEGRAFF, 3119 Turnberry Way, Jamul, CA, 91935, US

(21) Appl. No.: 11/759,164

(22) Filed: Jun. 6, 2007

(51) Int. Cl. H04L 9/00

(52) U.S. Cl. 705/64

(57) ABSTRACT

A method and system for distributing products is provided. The distribution system enables a manufacturer of a product to define one or more allowed distribution paths, and to limit distribution of their product to only an allowed distribution path. The system provides an embedded processor in or on a product, with the embedded processor controlling access to some utility or feature of the product. In this way, the product is not usable or is undesirable until an authorized activation process has occurred. To control the distribution chain, a set of distribution rules is defined that sets allowed or excluded distributors and retailers for products or sets of products. When the product is moved to the next distributor, or presented at a point-of-sale, the rules are compared to the actual recorded distribution chain. If the distribution chain is proper, then the product may be activated, or moved to the next distribution entity. If the distribution chain is not proper, than the product may be permanently disabled, or a response may be generated that penalized the infracting distributor.

This application is related to U.S. patent application Ser. No. 11/259,185, filed Oct. 26, 2005, and entitled “Method and System for Selectively Controlling the Utility of a Target”, which is incorporated herein in its entirety.

### BACKGROUND

The present invention relates to devices and network processes for managing and controlling the distribution of products. In a particular example, the invention relates the activation or authorization of a product contingent on confirmation that an authorized distribution chain has been used.

Manufacturers face a difficult problem in managing their distribution chains to assure products are safely and properly delivered to consumers. The manufacturer typically uses a distribution chain and retailers to bring its products to consumers. The manufacturer relies on the integrity of its distributors and retailers to assure that their products are properly sold or otherwise delivered. In a similar manner, the distributors and retailers rely on the manufacturer to provide a reliable product, and to assure that the product is delivered to them in proper condition. Building and maintaining such a trusted relationship between the manufacture, distributors and retailers is time consuming and takes considerable effort and resource to monitor.

The ability to build and maintain a trusted distribution network is important to all manufacturers, and is particularly critical in some product fields. For example, the distribution of pharmaceuticals, food products, and medical supplies require great trust between each party in the distribution chain. Unfortunately, commercial pressures may lead some distributors to act against the good of the entire distribution team, thereby eroding the trust and good-will built by the manufacturer. For example, a manufacturer may want to limit distribution to a select few high-end distributors, and therefore reaches exclusive distribution arrangements with a handful of premier distributors. In the agreement, each distributor may agree to sell products only in a specific geographic area, and to provide a high level of after-sale support in its area. In this way, the manufacturer may be confident that its product is sold and serviced in a way that maintains the highest of customer satisfaction and reputation. But, if one of the distributors is unable to sell its inventory in its assigned area, it may attempt to “dump” the product into the market using other channels. These products may be sold into other distributors exclusive areas, which will strain relations with those distributors, and may cause consumers to have undesirable service experience, which tarnishes the reputation of the manufacture and its products. It is therefore in the best interest of the manufacturer, the consumer, and the retailer to assure that products are properly sold.

Manufacturers may want to tightly control distribution and point of sale entities to ensure that their products are appropriately positioned in the market and are affiliated with distributors and retailers with a particular profile or perceived quality. In addition, many products are stolen and redistributed to purchasers without their knowledge or in many cases without the knowledge of the direct distributor, the misappropriation having occurred earlier in the supply chain. This can negatively effect the purchaser's perception of the quality of the product as well as the level of product sales of the legitimate distributor. Moreover, if the manufacturer can provide assurances to retailers that its products cannot be sold and redistributed, its products will have a higher value and can be positioned to command a higher price from the distributor.

Challenges also exist for non-commercial distribution of goods. For example, the military stores, transports, and maintains weapons and gear that is subject to movement though a military distribution chain. It is vital that these goods have a defined and trusted distribution path to assure integrity of the delivered products. Indeed, the military uses considerable resource to track movement of goods through its massive infrastructure and among its multitude of logistics groups.

### SUMMARY

The present invention provides a method and system for distributing products. The distribution system enables a manufacturer of a product to define one or more allowed distribution paths, and to limit distribution of their product to only an allowed distribution path. The system provides an embedded processor in or on a product, with the embedded processor controlling access to some utility or feature of the product. In this way, the product is not usable or is undesirable until an authorized activation process has occurred. To control the distribution chain, a set of distribution rules is defined that sets allowed or excluded distributors and retailers for products or sets of products. When the product is moved to the next distributor, or presented at a point-of-sale, the rules are compared to the actual recorded distribution chain. If the distribution chain is proper, then the product may be activated, or moved to the next distribution entity. If the distribution chain is not proper, than the product may be permanently disabled, or a response may be generated that penalized the infracting distributor.

The manufacturer is enabled to define an allowed distribution path, and control the way their products reach consumers. This distribution path may include various distributors and allowable point-of-sale retailers. The path may also include shipping companies, warehousers, bonded agents, freight forwarders, and online retailers. It will be appreciated that the distributors may be individually identified, or may be identified by their attributes, characteristics or classification. For example, a manufacturer may not want their product sold through an online service, so would define that only physical retail locations could operate a point-of-sale device for this product. By allowing for use of class-level inclusion or exclusion, as well as entity-level inclusion or exclusion, enables a simple and flexible way to control distribution.

Advantageously, the present invention enables a manufacturer to easily and automatically enforce distribution guidelines. This helps to assure that the manufacturer's products are delivered in a way consistent with the product's service and support requirements, as well as to maintain compliance with licensing limitations or government regulations. In this way, manufacturers are better able to deliver high-quality products consistent with consumer expectations.

### BRIEF DESCRIPTION OF DRAWINGS

FIG. 1 is a diagram of a product distribution system in accordance with the present invention.

FIG. 2 is a diagram of rules for a product distribution system in accordance with the present invention.

FIG. 3 is a diagram of a product distribution system in accordance with the present invention.

FIG. 4 is a diagram of token management for a product distribution system in accordance with the present invention.

FIG. 5 is a diagram of token management for a product distribution system in accordance with the present invention.

FIG. 6 is a diagram of token management for a product distribution system in accordance with the present invention.

FIG. 7 is a diagram of a product distribution system in accordance with the present invention.

FIG. 8 is a diagram of a product distribution system in accordance with the present invention.

### DETAILED DESCRIPTION

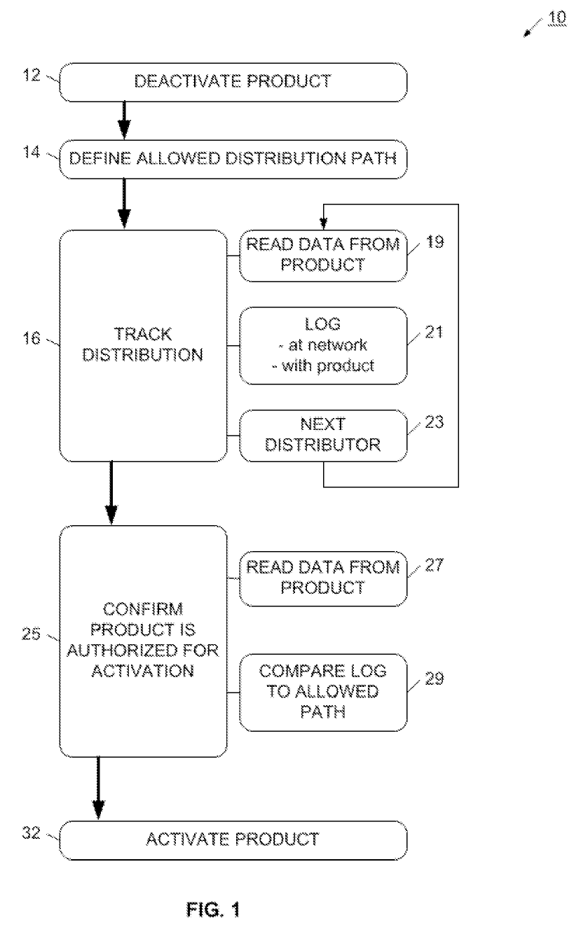

Referring now to FIG. 1, distribution process 10 is illustrated. Distribution process 10 enables a manufacturer of a product to maintain the integrity of the distribution chain for that product from the manufacturer, through various distributors, and to a point of sale. In this way, the manufacturer can more particularly control the delivery of products to consumers. Process 10 has a manufacturer deactivate a product as shown in block 12. For example, the product may have an embedded processor, logic, and radio that couple to operational circuitry. The embedded processor has a switch or other changeable device that is set to a state that causes the operational circuitry of the product to have no or very limited utility. In this way, the product would not be useful to anyone stealing or obtaining the product in an unauthorized way. This denial of benefit process removes the benefits of theft, so products may be less prone to pilfering and theft. The product may be, for example, an electronic device, a computer, an integrated circuit, a game, or a TV. In some cases, the operational circuitry in the product may be circuitry for selectively allowing an optical disc product to be read by its player, or may be a changeable label or indicia attached to the product. It will be understood that the distribution process of FIG. 1 may be applied to a wide range of electronic or non-electronic products.

The manufacturer defines an allowed distribution path as shown in block 14. This distribution path may include various distributors and allowable point-of-sale retailers. The path may also include shipping companies, warehousers, bonded agents, freight forwarders, and online retailers. It will be appreciated that the distributors may be individually identified, or may be identified by their attributes, characteristics or classification. For example, a manufacturer may not want their product sold through an online service, so would define that only physical retail locations could operate a point-of-sale device for this product. Allowing for use of class-level inclusion or exclusion, as well as entity-level inclusion or exclusion, enables a simple and flexible way to control distribution.

The product then enters the distribution chain, and its progress is tracked as shown in block 16. In one example, each distributor that handles the product reads data from the product as shown in block 19. For example, each distributor may use a radio frequency RFID system to read a product ID from the embedded processor associated with the product. The distributor's handling of the product is logged as shown in block 21. In one example, the distributor communicates to a central network operations center and communicates their distributor ID and the product data to the network operations center. In this way, the central network operations center maintains a list of every distributor that handled the product. In another example, the distributors handling the product are logged into the embedded processor associated with the product. For example, each distributor's ID may be wirelessly communicated to the embedded processor, where it is stored. In another example, the distributor reads a token value from the embedded processor, and then encrypts the token to the distributor's private key. The distributor then wirelessly communicates the encrypted token back to the embedded processor where it is stored. Further, the distributor may report its activity to the network operations center so that the network operations center can maintain a central listing of all distributors handling the product. The product may then be moved to the next distributor in the distribution chain, as shown in block 23.

As described above, the distribution path has been logged in the product's embedded processor, centrally, or both in the embedded processor and at the network operation center. In this way, when the product is presented to a point-of-sale device, the product can be confirmed to have passed through an authorized distribution path, and is ready for activation as shown in block 25. More particularly, a consumer may move the product to a point-of-sale location, such as a retail check-out position, where an RFID communication device reads data from the product as shown in block 27. The log of actual distributors is compared to the allowed distribution path as shown in block 29. Provided the actual distribution path is an allowed path, then the point-of-sale communication device may proceed to activate the product as shown in block 32. In some cases, the network operations center may assist in determining that an allowed distribution path has been maintained, and if so, may generate or retrieve a key or code that is communicated to the point-of-sale RF device. The point-of-sale RF communication device then communicates the key to the embedded processor in the product, where the embedded processor confirms that the product may be activated. Although the activation and activation processes shown in blocks 12 and 32 are generally defined herein, copending U.S. patent application Ser. No. 11/259,185, filed Oct. 26, 2005, and entitled “Method and System for Selectively Controlling the Utility of a Target”, more fully sets out a deactivation and activation process, and is incorporated herein in its entirety.

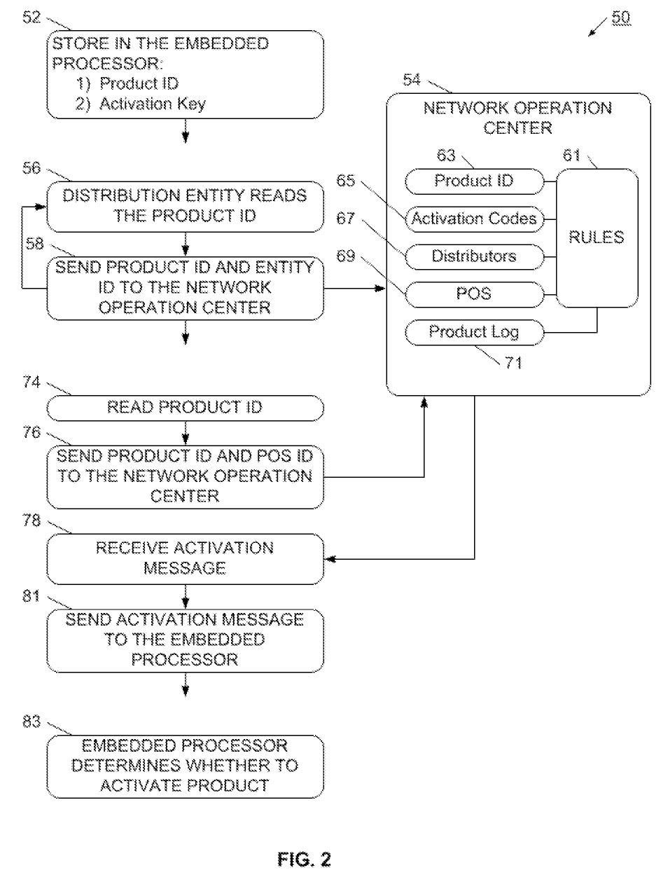

Referring now to FIG. 2, distribution process 50 is illustrated. Distribution process 50 has a manufacturer store a product ID and activation key in an embedded processor as shown in block 52. The embedded processor is associated with the product in a way that the embedded processor securely and unalterably attaches or connects to the product. For example, the embedded processor may be internal to electronic or other systems, may be physically secured inside a case, or may be unalterably attached on a labeling system. The embedded processor has an associated wireless radio system and antenna for receiving and sending communications. These communications are typically radio frequency (RF), but other wireless systems may be used such as NFC (near field communication) or Felica. The embedded processor also couples to a switch that has at least two states: a first state that disables the utility, attractiveness, or usefulness of the product, and a second state that allows full activation and use of the product. When the manufacturer first ships the product, the switch is set to the state where the product is deactivated. In this way, the product is undesirable for theft, as its utility has been disabled or substantially reduced. In this way, the product may be moved to the distribution chain with substantially reduced risk of theft.

As the product is passed to each distributor, the distributor reads the product ID which has been stored in the embedded processor as shown in block 56. Typically, each distributor would use a wireless reader to read the product ID, and then send that product ID and the distributor's ID to a network operations center as shown in block 58. The network operations center typically is a centrally located facility for managing the distribution process, although it may be a server or other processor positioned in a retail store, for example. Network operations center 54 has one or more computer server systems which maintain a list of all product IDs 63, a set of activation codes or a process for generating or extracting activation codes 65, a set of authorized distributors 67, a set of allowed point-of-sale entities 69, and a product log 71. It will be understood that the products ID's, codes, distributors, or retailers may be identified by class or category to reduce storage requirements. Each time a distributor handles a product, the network operations center may confirm that a valid product ID has been received, a valid distributor ID has been received, and that the distributor was authorized to handle the particular product. This information may then be stored in product log 71. Network center 54 also maintains a set of rules 61 that define which distributors and point-of-sale entities may handle each product. These rules may be set to track individual products, individual distributors, and individual point-of-sale retailers, or it may be set by grouped characteristics or classifications. Each time the product moves to a new entity in the distribution chain, that distributor follows a process as shown in blocks 56 and 58. In this way, a product log 71 is generated which lists all distributors having handled the product.

When the product is presented at a point of sale device, the retailer or other point-of-sale entity reads a product ID from the product as shown in block 74. Again, the retailer typically uses a wireless radio system to retrieve the product ID. The product ID and point-of-sale ID is sent to the network operations as shown in block 76. The network operations center 54 compares the product ID and retail ID to confirm that the retailer is authorized to handle the product, and enters the information into the product log 71. The product log 71 is then compared to the rules 61 to assure that each and every distributor and point-of-sale entity was authorized to handle the product. It will be understood that rules 61 may be quite simple or more complex depending on application needs. For example, rules 61 may define a set of allowable distributors, either particularly or by characteristics or class. Rules 61 may also set a list of disallowed distributors or retailers, again individually or by class or characteristic. Rules 61 may also be set to define a number of distributors or point-of-sale entities that must handle the product, or it may define a particular order in which the distributors must handle the product. It will be appreciated that a wide arrangement of rules are available. It will also be understood that the wireless radio device may be an NFC-enabled wireless mobile handset or a computer-attached RF reader. In this way, a consumer may purchase and activate products at home, for example.

Provided the network operations center confirms that the product log 71 indicates an allowable distribution path, the network operations center retrieves, generates, or extracts an activation code and sends an activation message to the point-of-sale device, which receives the activation message as shown in block 78. The point-of-sale RF device sends the activation message, which typically includes the activation key or code, to the embedded processor attached or integral to the product, as shown in block 81. In the case where the product has taken an unauthorized distribution path, the activation message may include a code intended to permanently disable the product. The embedded processor compares or otherwise logically operates on the activation code and determines whether or not the product may be activated. Provided the proper activation code was received, the embedded processor causes the switch to move to a state that fully activates the product, and the product is activated as shown in block 83.

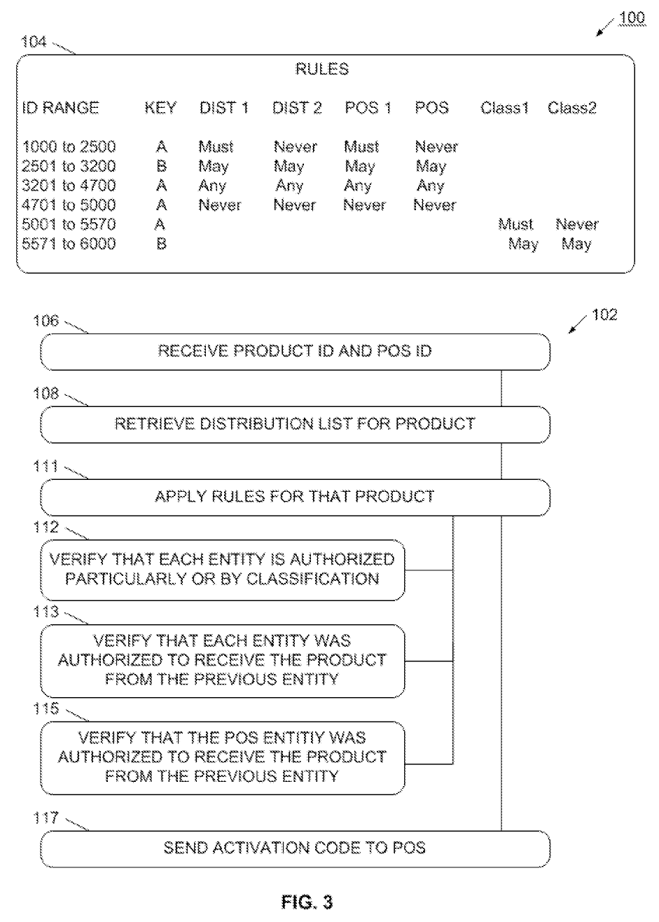

Referring now to FIG. 3, a set of rules 100 is illustrated. Rule list 104 has a list of product IDs supplied by a manufacture. Each product ID range has an encryption key associated with it, which may be used by the network operations center to assist in decrypting messages received for the product. Each range of product IDs may have a set of distributors, set of point-of-sale entities, or entities defined by classification or characteristic, that make up its allowed list of distributors. Rules 104 illustrate some of the ways in which a distribution set may be defined. For example, the product with ID number 2501 may be handled by any combination of distributor 1, distributor 2, point- of-sale 1, or point-of-sale 2. In contrast, the product with ID 1000 must only go from distributor 1 to point-of-sale 1, with any other combination being disallowed. Also, the product with ID number 4701 may never be sold or distributed. This may be useful for removing certain ranges of products from the distribution chain, for example, if the products are defective or recalled. Product with number 5001 must be distributed by a class 1 distributor and may never be sold by a class 2 distributor, while the product with ID number 571 may be sold by either a class 1 or class 2 distributor. It will be understood that the classifications of distributors and point-of-sale entities may define these entities in terms of location, level of support, type of equipment installed, volume, or other characteristic.

Rules 104 are applied using a distribution process 102. Process 102 may advantageously be operated at a point-of-sale location. A point-of-sale location may be, for example, a retail outlet, a kiosk, a vending machine, or may be an at-home activation using a wireless handset of a computer-attached RF reader. The point-of-sale terminal device has a wireless radio that retrieves a product ID from the product as shown in block 106. The product ID and the point-of-sale IDs are communicated to a network operations center where the authorized distribution list for that product is retrieved as shown in block 108. The network operations center applies the rules for that product to confirm that the product has followed an authorized distribution path as shown in block 111. More particularly, the rules may verify that each entry is authorized particularly or by classification as shown in block 112. In some cases, the rules may define a particular ordering of distributors, so that the rules could verify that each entity was authorized to receive the product from the previous entity as shown in block 113. In a similar way, the rules could confirm that the point-of-sale entity was authorized to receive the product from the previous distribution entity as shown in block 115. It will be appreciated a wide number of rules may be applied.

Provided that an allowed distribution path was followed, the network operations center sends an activation code to the point-of-sale as shown in block 117. This activation code would then be used by the point-of-sale wireless device to send the code to the product, so the product could be activated. It will be understood that the network operations center may retrieve the activation codes from a stored list, may generate the activation code a according to algorithmic processes, or may extract the activation code from encrypted messages received from the product. It will also be understood that the activation code may be generated and communicated in alternative ways.

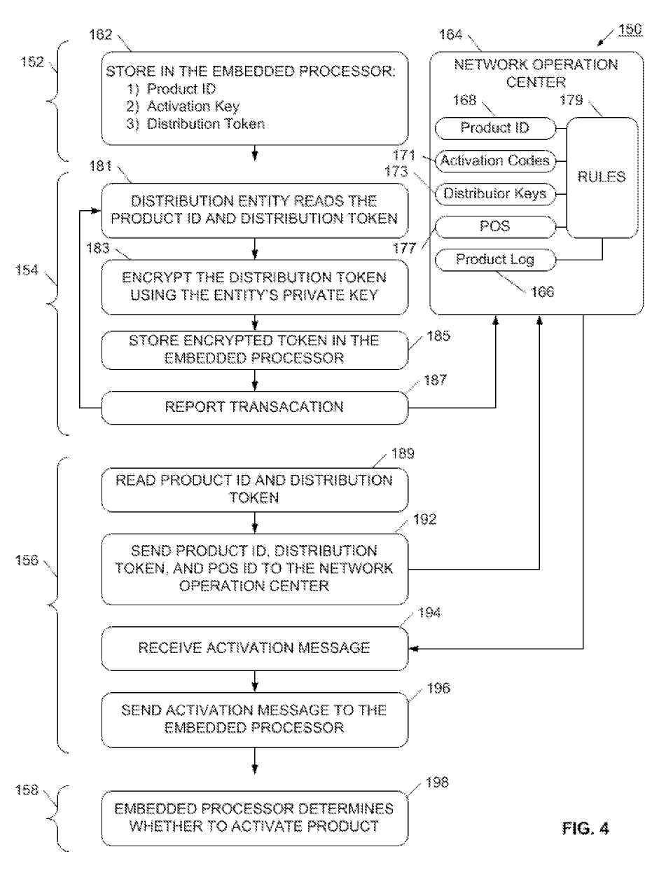

Referring now to FIG. 4, a distribution process 150 is illustrated. Distribution process 150 has manufacturer activities 152 which are performed by the manufacturer prior to the product entering the distribution chain. The manufacturer has a product which has an associated embedded processor in which a product ID, activation key and distribution token are stored as shown in block 162. The embedded processor has an associated radio and antenna for receiving and sending RF communications. The embedded processor also has a switch which is set to a state that deactivates the product, so that the product has limited or no utility, or is made aesthetically unappealing. In this way, the product may be transferred through the distribution chain with significantly reduced risk of theft.

The product then enters the distribution chain 154. As each distributor handles the product the distribution entity reads the product ID and distribution token as shown in block 181. The distribution entity encrypts this distribution token using that entity's private encryption key as shown in block 183. The distribution entity re-stores the encrypted token back onto the embedded processor as shown in block 185, and reports the transaction to a network operations center as shown in block 187. In this way, the network operations center maintains a product log 166 which shows each distributor that handled the product. The network operations center also maintains a list of product IDs 168, activation codes or processes for determining activation codes 171, a set of distributor public keys 173, and a list of point-of-sale entities 177. The network operations center also has a set of rules 179 which define one or more allowed distribution paths for each product. Each distributor that handles the product follows this process of reading the previously encrypted token from the product, and then encrypting the token to the distributor's private encryption key. In this way a multi-level encrypted token is generated and stored on the embedded processor that is associated with the product. In one example, the original distribution token is the same as the activation key secretly stored in the embedded processor with the product. Accordingly, when the token is decrypted through its multiple levels using the set of public keys 173, and the proper sequence of decrypting keys were used, the unencrypted token will match the activation key previously stored on the embedded processor. This process provides a simple and secure mechanism for authenticating and confirming a distribution path.

At the point-of-sale 156 the product ID and multi-level encrypted distribution token are read from the product's embedded processor as shown in block 189. The point-of-sale device sends the product ID, distribution token, and point-of-sale ID to the network operations center as shown in block 192. The network operations center 164 confirms that the point-of-sale ID is from a proper point-of-sale entity, and begins decrypting the distribution token. In this regard, the network operations center reviews the product log 166 to identify each distribution entity which handled the product, and retrieves their associated distributor public key 173. The network operations center sequentially decrypts the distribution token in reverse order that it was encrypted. This multi-level decryption process authenticates that only trusted distributors handle the product. The network operations center 164 may also apply a set of rules 179 to the product log 166 to confirm that only allowed distributors were used, or that the product followed the allowed or required distribution path. In this way, the network operations center can confidently confirm that a product has passed through an allowable distribution chain before activating the product.

Provided an allowed distribution chain was followed, the network operations center sends an activation message to the point-of-sale device which is received at the point-of-sale device as shown in block 194. In one example, this activation message is the decrypted distribution token. The activation message is then communicated to the embedded processor as shown in block 196. Typically, the activation message would be communicated through an RF communication. The embedded processor associated with the product then uses the activation message to determine whether to activate the product as shown in block 198. In one example, the decrypted distribution token was received as the activation message, which will match the secretly stored activation key if the product is ready to be activated. It will be appreciated that other more sophisticated logic may be applied to determining when to activate the product.

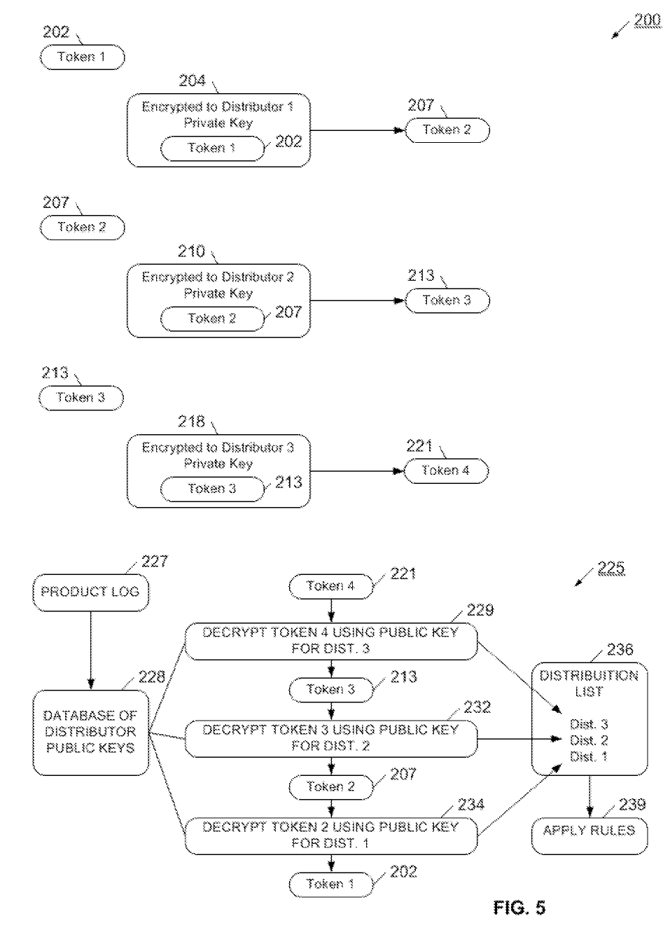

Referring now to FIG. 5, a distribution encryption process 200 is illustrated. In process 200 a first distributor reads a distribution token 202 from an embedded processor associated with the product. The first distributor encrypts token 202 to that first distributor's private key as shown in block 204, which generates a first level encryption token 207. The first distributor stores token 207 back on to the embedded processor. A second distributor receives the product and reads token 207, and encrypts token 2 to the second distributor's private key as shown in 210, which generates a second level encrypted token 213. Again, distributor 2 stores token 213 back onto the embedded processor. A third distributor reads token 213 from the embedded processor, and encrypts that token to the third distributor's private key as shown in block 218, and generates token 221 which is stored back on the embedded processor. Each of the distributors has also reported the transaction to a network operations center.

Later, when the product is at a point-of-sale location, a decryption process 225 will be applied. The point-of-sale device reads distribution token 221 from the embedded processor with the product, and passes token 221 to a network operations center. The network operations center has a product log 227 which identifies the distributors which have handled that product, and the order in which they were handled. The network operations center also has a database of distributor public keys 228, so that decryption keys may be retrieved. As shown in block 229, the network operations center takes token 221 and decrypts token 4 using the public-key for distributor 3, which generates token 213. As shown in block 232, token 213 is then decrypted using the public key for distributor 2, which generates token 207. Finally, as shown in block 234, token 207 is decrypted using the public-key for distributor 1, generating the original token 202. The network operations center also maintains an allowable distribution list 236 and a set of rules 239 for determining if an allowed distribution path has been followed. Provided an allowable path has been followed, the network operations center may send an activation message to the point-of-sale terminal, so that the point-of-sale terminal may communicate the activation key to the product. Typically, the activation message will include token 1 (202). In the embedded processor, the received token 1 is compared to a stored secret code, and if they match, the embedded processor proceeds to activate the product.

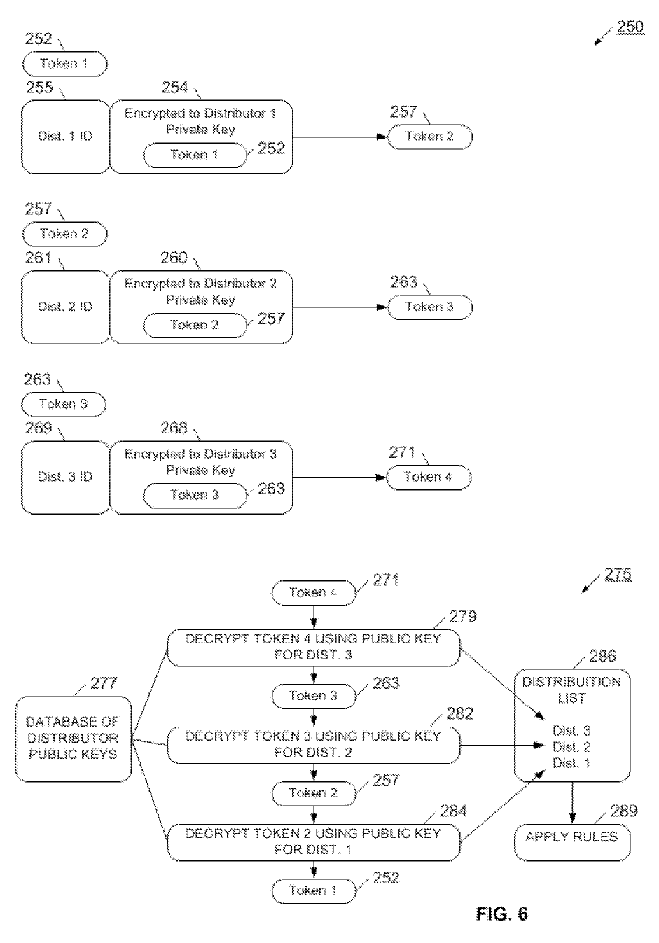

Referring to FIG. 6, another encryption process 250 is illustrated. In the process 250, a first distributor reads token 1 (252) from the embedded processor of a product. Distributor 1 builds a message which consists of the distributor's ID 255 plus an encrypted version 254 of token 1 (252). This message becomes token 2 (257), which the first distributor stores on to the embedded processor. A second distributor reads token 2 (257) and again forms a message which uses the second distributor's ID 261 plus an encrypted version 260 of token 2 (257), which generates token 3 (263), which is stored back onto the embedded processor by the second distributor. Token 3 (263) is later read by the third distributor, which adds its distributor ID 269 to encrypted version 268 of token 3 (263) and generates and stores token 4 (271) on to the embedded processor. In this way, the embedded processor carries more information regarding the distribution chain, which allows less information to be transmitted to the network operations center during distribution of the product. In this example, the product's embedded processor itself holds information regarding the entire distribution chain, including the identification of each distributor, as well as the “key” to activate the product.

Later, when the product is at a point-of-sale, a decryption process 275 may then be applied. The point-of-sale device reads token 4 (271) from the product. Token 4 (271) includes the distributor 3 ID, so the network operations center can use a database of distributor public keys 277 to determine the public-key for decrypting token 4 (271). The token 4 (271) is decrypted as shown in block 279, and distributor 3 is added to the distribution list 286. In a similar manner, token 3 (263) identifies distributor 2, so that the distributor 2 public-key may be used to generate token 2 (257) as shown in block 282. Again, distributor 2 is added to the distribution list 286. Finally, token 2 (257) includes identification of distributor 1, so distributor 1's public-key may be used to decrypt to token 1 (252), as shown in block 284. Distributor 1 is added to distribution list 286. In this way, the original token 1 (252) may be extracted, and a complete and verified distribution list 286 is generated. The network operations center may then apply a set of allowed rules 289 to confirm that the actual distribution of the product followed an allowed path. Provided that only allowed paths were followed, the network operations center may send an activation message to the point-of-sale device capable of activating the product. Typically, the activation message will include token 1 (252). In the embedded processor, the received token 1 is compared to a stored secret code, and if they match, the embedded processor proceeds to activate the product.

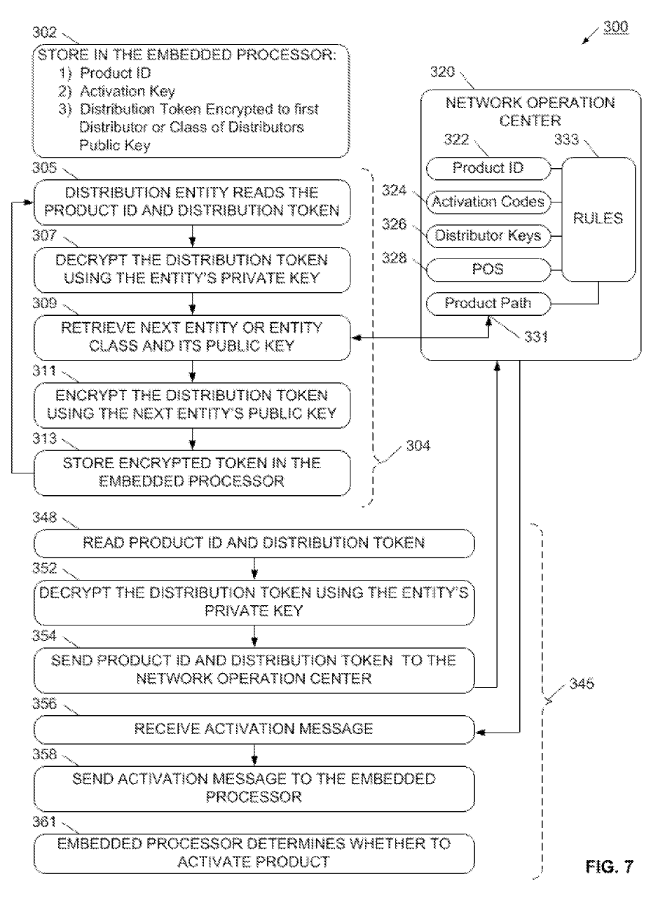

Referring now to FIG. 7, a distribution process 300 is illustrated. In process 300, a manufacturer stores a product ID, activation key and an encrypted token on the embedded processor. The activation key may be, for example, a secretly stored key which may not be externally read and is unalterable. In this way, the activation key may be used by the embedded processor to confirm when activation is to be performed. As in previous processes, the manufacturer has disabled the product. More particularly, the embedded processor couples to a switch that controls the level of utility for the product. When the switch is in an inactive state, the utility of the product is substantially reduced, so that if stolen, the product will be of little to no use to any thief. In this way, the product may be more readily processed through the distribution chain, and more easily presented in a retail environment The embedded processor has a stored encrypted token, with the token encrypted to the public key of the next expected distribution entity. In this way, an entity having possession of the product can define the next entity, or a class of entities, for receiving the product. Accordingly, the next distribution entity receives the product and reads the product ID and distribution token as shown in block 305. The distribution token can be decrypted using that entity's private key 307. The token may then be communicated to the network operations 320 where the network operations center can confirm that a proper token has been received. Provided a proper token has been received for the product, the network operations center may send a message to the distributor indicating the next entity to receive the product as shown in block 309. This communication may include the next entity's public key, or the distributor may use available public key databases to determine the public-key for the next distribution entity. The distributor then encrypts the distribution token to the next entity's public key 311, and stores that encrypted token back on the embedded processor as shown in block 313. In this way, distributor processes 304 allow a distributor to confirm that it has received a product from an authorized entity, and allows that distributor to set with particularity the next entity or entities authorized to receive the product.

The network operations center 320 maintains a set of product IDs 322, activation codes or processes to generate activation codes 324, distributor public keys 326, a list of point-of-sale entities 328, and a product path 331. This product path defines an allowed distribution or entity path for the product. In this way, any reporting distributor may determine what the next entity or set of entities may be for a product or set of products. Using this information, the current distributor may encrypt a token specific to the needs of the next distributor.

Later, when the product is at a point-of-sale location 345, the product ID and distribution token is read by the point-of-sale device as shown in block 348. The point-of-sale entity can decrypt the distribution token using that entity's private key as shown in block 352. The product ID and decrypted token is then sent to the network operations center as shown in block 354. The network operations center can thereby decrypt or otherwise process the messages and confirm that an allowed distribution channel has been used, for example, by comparing the distribution path to predefined distribution rules 333. Provided all is in order, the network operations center may generate an activation message which is sent to the point-of-sale device as shown in block 356. The point-of-sale device may use its radio to communicate the message to the embedded processor as shown in block 358. Provided the activation message is proper, the embedded processor may change the state of the switch to fully activate the product as shown in block 361.

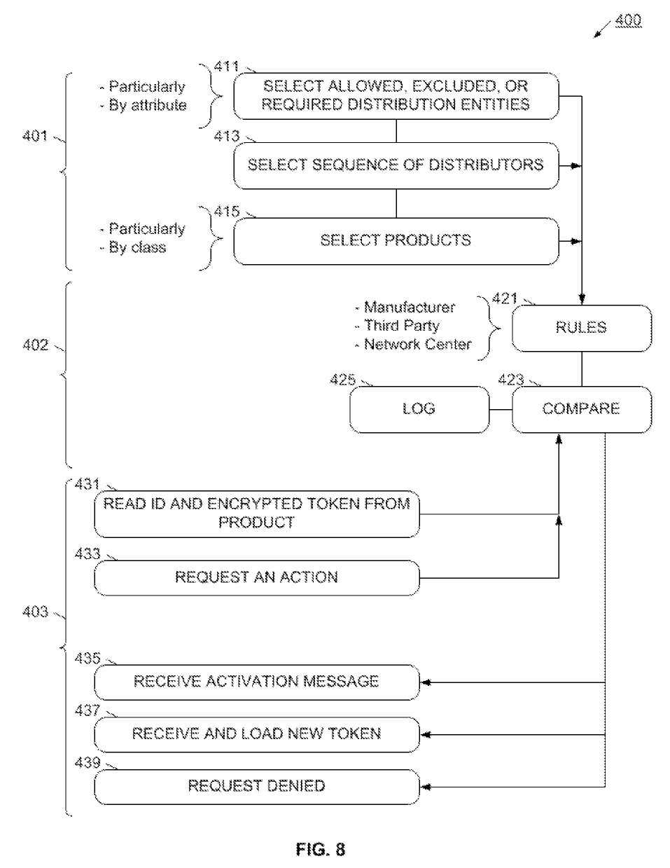

Referring now to FIG. 8, a controlled distribution system 400 is illustrated. System 400 has manufacturing activities 401 that are typically performed by the manufacturer of a product, although another distribution entity may perform these functions. In block 411, the manufacturer defines an allowed distribution path for its product. The distribution path may be set for a particular product, or may be set for a class or set of products, for example, by attributes assigned to the product. In a similar manner, the allowed or excluded distributors may be defined individually or by an attribute or characteristic of the entity. In this way, each distributor may have a set of attributes, and the allowed path may include or exclude distributors according to the attribute values. For example, when distributors are loaded into the system, they may be assigned an attribute that defines whether they are an on-line retailer. Then, when defining a distribution path, the complete class of on-line retailers may be allowed or excluded by evaluating this attribute. It will be understood that may attributes may be defined, and that these attributes may be manipulated in a variety of ways.

A particular sequence or order of distributors may be defined, as shown in block 413. In this way, the manufacturer can be assured that a particular distributor has not been excluded from the authorized chain. For example, the manufacturer may want only retail stores to sell their products, and want to assure that one of the upstream distributors does not sell products directly to consumers, or tries to sell products through an on-line seller. The distribution order may be defined using specific entities, or may be done by classification or attributes.

The manufacturer may also define which products are to be controlled, as shown in block 415. These products may be defined by item-level ID values, a range of product values, by class or product, or by an attribute associated with the product. A set of rules 421 may then be set that define the allowed and unauthorized distribution chain for a product or set of products. The network center 402 maintains these rules 421, which are used to determine if a proper distribution path is being maintained. For example, as the product is moved through the distribution chain, each distributor requests an authentication of the product and authorization that it is allowed to have the product. This is done by comparing 423 a request from a distributor to the current rules 421. These requests, as well as the actual distribution path, may be recorded in a log 425.

Distribution activities 403 may apply to any distributor handling the product, including the point-of-sale entity. The distribution activities typically are used when the product is moved from one entity to another, for example, from the manufacturer to a trucking company, or from a retailer to a customer. The entity in current possession of the product reads an ID and an encrypted token for the product, as shown in block 431. The ID and token are transmitted to the network operation center, typically along with an entity identifier. The entity identifier may be separate, or may be included in the ID or in the token message. The network may then decrypt the token, for example, using a public key associated with the entity's ID. The entity may also be requesting an action 433, such as requesting an activation key, or requesting a new token that has been encrypted for the next authorized distributor. The network system 402 uses the rules 421 and log 425 to confirm that the current distributor is authorized to have the product. For example, the log 425 has recorded previous distribution entities, and the network can confirm whether the presented product has moved through an allowed distribution path. If so, the network may authorized the requested action, and proceed to transmit activation or other messages as appropriate.

In a point-of-sale example, a request 433 may have been made to activate the product. Provided the product has moved through a proper distribution chain, the network 402 may proceed to decrypt the received token and send the decrypted token to the product's embedded processor as an activation message 435. In an example where a distributor has requested 433 to load a new token specific to the next distributor, the network first determines that the product has moved through a proper distribution chain. If so, the network 402 may proceed to generate a new token, and send the new token to the product's embedded processor along with a command to load the new key, as shown in block 437.

In the case where the network 402 determines that the product is not following an authorized distribution path, the network may deny the action request, as shown in block 439. The denial 439 may be a simple communication that identifies the product as being outside the authorized distribution chain, or may include a kill message that permanently disables the ability of the embedded processor to activate the product. In this way, a product outside the authorize chain can be permanently disabled, providing strong incentive for distributors to only act according to the established distribution guidelines. It will also be appreciated that the network may proceed to activate the product, even if an unauthorized path has been taken, and record the transgression in the log. In this way, the product is not disabled, but the infraction may be handled through other processes, such as negotiation or revenue adjustments. For example, a distributor that repeatedly violates distribution rules may have their contract cancelled, or may have to pay penalties.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A distribution process, comprising:
receiving a message from each distributor that handles a product, each respective message identifying the product and the respective distributor;
receiving a message from a point of sale device, the point of sale message indicating that the product is requesting activation;
confirming that only authorized distributors handled the product; and
sending an activation message to the point of sale device, the activation message corresponding to a code stored with the product.

2. The distribution process according to claim 1, further including the step of logging each of the distributors into a product log, the product log tracking which distributors handled each product.

3. The distribution process according to claim 1, wherein the confirming step further comprises: a) confirming that the distributors satisfy a set of allowed distributors; b) confirming that the distributors satisfy a set of required distributors; c) that the distributors satisfy an allowed ordering of the distributors; or d) that the distributors satisfy a required ordering of the distributors.

4. The distribution process according to claim 1, further including the step of decrypting each message using a public key for the respective distributor.

5. The distribution process according to claim 1, wherein the point of sale message includes a product identification.

6. The distribution process according to claim 5, wherein the product identification is used to retrieve the activation message.

7. The distribution process according to claim 1, wherein the point of sale message includes an encrypted version of the activation message.

8. The distribution process according to claim 1, further including the step of sending the activation code to the product using an RF or NFC radio device.

9. The distribution process according to claim 1, wherein the step of sending the message from the distributor includes the step of reading the product identification information from the product using an RF or NFC radio device.

10. A distribution process for a product, comprising:
reading a token from an embedded processor associated with the product;
encrypting the token to a current distributor's private key; and
sending the encrypted token to the embedded processor for storage.

11. The distribution process according to claim 10, further including the step of communicating the current distributor's identification to a network operation center.

12. The distribution process according to claim 10, further comprising:
receiving the product at a next distributor;
reading the encrypted token from the embedded processor;
encrypting the token to the next distributor's private key to generate a multi-level encrypted token; and
sending the multi-level encrypted token to the embedded processor for storage.

13. The distribution process according to claim 12, further including the step of communicating the next distributor's identification to a network operation center.

14. The distribution process according to claim 10, further comprising:
reading the encrypted token;
using the current distributor's public key to decrypt the token;
confirming that the token is valid; and
sending, responsive to the confirming step, an activation message to the embedded processor.

15. The distribution process according to claim 14, wherein the token is indicative of the activation message.

16. The distribution process according to claim 14, wherein the token is the activation message.

17. The distribution process according to claim 14, further including the step of accessing a log of distributors that handled the product, and using the log to retrieve the distributor's public key.

18. The distribution process according to claim 14, further including the step of accessing a log of distributors that handled the product, and comparing the log to a set of distributors authorized for that product.

19. The distribution process according to claim 14, further including the step of sending the activation code to the embedded processor using an RF or NFC radio device.

20. The distribution process according to claim 19, wherein the comparing step further comprises: a) confirming that the distributors satisfy a set of allowed distributors; b) confirming that the distributors satisfy a set of required distributors; c) that the distributors satisfy an allowed ordering of the distributors; or d) that the distributors satisfy a required ordering of the distributors.

21. The distribution process according to claim 19, wherein the comparing step further comprises: a) confirming that all the distributors satisfy a set of characteristics; or b) confirming that all the distributors belong to a class of distributors.

22. The distribution process according to claim 10, further including the step of reading the token from the embedded processor using an RF or NFC radio device.

23. The distribution process according to claim 10, further including the step of sending the encrypted token to the embedded processor using an RF or NFC radio device.

24. A distribution process, comprising:
providing a deactivated product;
defining a set of allowed distributors;
reading a message from the product as each distributor handles the product;
logging each distributor that handles the product;
receiving a message indicating that the product is requesting activation;
confirming that the logged distributors are within the set of allowed distributors; and
sending an activation message to the product the activation message necessary to activate the product.

25. The distribution process according to claim 24, wherein the activation is not sufficient to activate the product.
